(19) United States
(12) Patent Application Publication
(10) Pub. No.: US 2010/0083143 A1
(43) Pub. Date: Apr. 1, 2010

(54) Internet banner system with live interaction

(76) Inventor: Joseph Bigley, Upper Montclair, NJ (US)

Correspondence Address: Gearhart Law LLC, 4 Femdale Avenue, Chatham, NJ, 07928, US

(21) Appl. No.: 12/455,960

(22) Filed: Jun. 9, 2009

Related U.S. Application Data
(60) Provisional application No. 61/131,533, filed on Jun. 10, 2008.

(51) Int. Cl. G06F 15/16; G06F 17/30; G06F 3/01

(52) U.S. Cl. 715/758; 709/203; 707/812; 709/231; 709/219; 709/206; 707/E17.044

(57) ABSTRACT

The present invention comprises a means to conduct interactive communication, including text chat, audio chat, and video chat, from within an internet banner context. Text chat, audio chat, and video chat are provided without the need to launch an additional application, or pop-up browser window. A comprehensive list of transactional data is available to administrators to analyze the effectiveness of internet banner advertisements and customer service transactions.

### CLAIM OF PRIORITY

This application claims priority to U.S. Ser. No. 61/131,533 filed Jun. 10, 2008, the contents of which are fully incorporated herein by reference.

### FIELD OF THE INVENTION

The present invention relates to the Internet. More specifically, the present invention relates to networking Internet users together in a “banner ad” or other media portal on a web page.

### BACKGROUND

The architecture of the Internet (or “Web”) follows a conventional client-server model. The terms “client” and “server” are used to refer to a computer's general role as a requester of data (the client) or provider of data (the server). Web browsers reside in clients and specially formatted “Web documents” reside on Internet (Web) servers. Web clients and Web servers communicate using a protocol called “HyperText Transfer Protocol” (HTTP). In operation, a browser opens a connection to a server and initiates a request for a document or a Web page including content. The server delivers the requested document or Web page, typically in the form coded in a standard “HyperText Markup Language” (HTML) format. After the document or Web page is delivered, the connection is closed and the browser displays the document or Web page to the user.

The Internet consists of a worldwide computer network that communicates using well defined protocol known as the Internet Protocol (IP). To access a document on the Web, the user enters a URL for the Web document into a browser program executing on a client system with a connection to the Internet. The Web browser then sends a request in accordance with the HTTP protocol to the Web server that has the Web document using the URL. The Web server responds to the request by transmitting the requested object to the client. Such objects often contain hyperlinks to other Web documents. Generally, users view the content delivered in the Web pages and may select hyperlinks to other sub pages of a Web site, or to entirely different Web sites.

The Internet is an advertising supported medium, wherein publishers sell advertising “space” on their web site to third parties in what are referred to as banner ads. These banners may be delivered to the user by the Web page's provider, or may be provided by a third party advertisement server. When an interested user selects the advertisement (by “clicking through” on the banner) the user is generally forwarded to another Web page or site associated with the advertisement. Internet banners are an important part of many e-commerce systems.

While the use of banner ads to deliver interactive functionality has existed for some time, current systems and methods have various shortcomings that prevent an optimal user experience, and fall short of desired effectiveness in terms of revenue generated from the advertisements. Therefore, what is needed is an improved Internet banner system that can provide an improved user experience, and increase the effectiveness of Internet banner advertising.

### SUMMARY OF THE INVENTION

The present invention provides an interactive internet banner that provides a means to conduct interactive communication, including text chat, audio chat, and video chat, from within an internet banner context. One of the important advantages of the present invention is that interactive communication is invoked directly from the internet banner, without the need to launch another application, or pop-up browser window. This is important because studies show that internet advertising loses effectiveness as more additional steps are required to get more information. By using the present invention, a caller (e.g. customer) can quickly access a presenter (e.g. live customer service representative) without the additional delay of launching another application. Furthermore, as no separate window is required for the user interface that supports the interactivity, the need for a pop-up is avoided, and therefore can increase the chance that an internet banner advertisement will result in a sales lead.

Another advantage of the present invention is the capability to collect important metrics about an interactive session. An interactive session can be thought of as comprising one or more user transactions. Each transaction is recorded to allow the interactive session to be analyzed in an offline manner. The user transactions that are recorded may include, but are not limited to, the time and date of each transaction, the text chat logs for each transaction, audio and video chat recordings of each transaction, location of callers, IP address of callers, and the duration of the transaction.

For example, it is often desirable to measure the effectiveness of customer support by the time required to solve the customer issue. To that end, recording the amount of time spent in each session is useful.

Another advantage is the strong cross-platform usability of the present invention. The present invention does not require a special application to be installed a priori, other than a standard computing environment with a web browser such as Internet Explorer, Mozilla, or Safari, to name a few. The present invention works with various platforms, such as Microsoft Windows, Linux, and Mac. These and other advantages will be come more apparent from the drawings and detailed description that follows.

### BRIEF DESCRIPTION OF THE DRAWINGS

FIG. 1 is a block diagram illustrating components of the present invention.

FIG. 2 is a flow chart indicating steps during a use of the present invention.

FIG. 3 is an exemplary banner in accordance with the present invention.

FIG. 4 is a detailed view of a banner during interactive communications.

### DETAILED DESCRIPTION

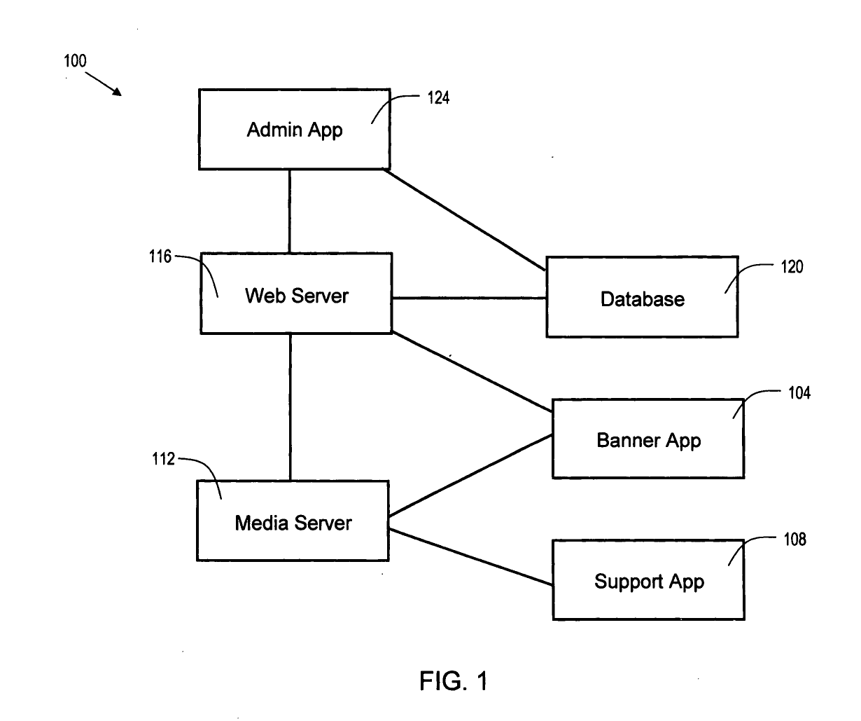

FIG. 1 is a block diagram 100 illustrating components of the present invention. A banner application 104 is invoked by a user via an internet banner. Internet banners can come from a variety of sources. However, it is a common practice to have internet banners served from an ad server. The present invention can be utilized and practiced regardless of the origin of the interne banner. The banner application 104 interacts with The customer service rep, logs onto to the back end console, which is hosted by Avivocom. It is a web based application. The customer service representative accepts “Calls” coming from banners or a mini site. The “call” is loaded into a “queue” box. The representative can then click on the “call” to begin a session with the user. A representative can handle multiple calls this way and toggle back and forth between calls using the tabs that each call creates in the console.

If no representatives are available, the client has the capability of sending a “We are busy message” to users who may want to initiate a call or send the caller to another page on the website for things like “call me back” or “send an email”

In an exemplary business context, the banner application is executed on a client computer of a caller (e.g. a customer), and the support application is executed on a client computer of a presenter (e.g. a customer service representative of a company). The communication session provides a means for live video and audio streaming between the support application 108 and banner application 104, thereby enabling the caller and presenter to communicate in real time. In one embodiment, the media server 112 is Flash Media Server, from Adobe Systems Incorporated of San Jose, California. In one embodiment of the present invention, various usage statistics regarding the customer's interaction with banner application 104 are communicated to a web server 116. These user statistics comprise ROI (return on investment) and engagement metrics that are valuable tools for advertisers to gauge the effectiveness of their ad content. From web server 116, the interaction information (referred to as a “transaction”) is stored in database 120. In one embodiment, the database used is MySQL. However, a variety of databases may be used, such as Oracle, and Access, for example. In one embodiment, web server 116 is configured to execute PHP scripts to interact with database 120, and administration application 124.

Administration application 124 is configured to communicate with web server 116 and database 120 to establish various administrative settings, and access user transaction information. Administrative settings information may include, but are not limited to, maintaining a list of banned IP addresses, as well as creation and management of accounts for presenters and administrators. The user transaction information may include, but are not limited to, the time and date of each transaction, the text chat logs for each transaction, audio and video chat recordings of each transaction, location of callers, IP address of callers, the duration of the transaction, and the activation URL of the internet banner that invoked the banner application 104 when selected by the caller. Administration application 124 may also be configured to generate reports of user transactions, such as the ability to sort transactions by duration, IP address, and date, to name a few examples.

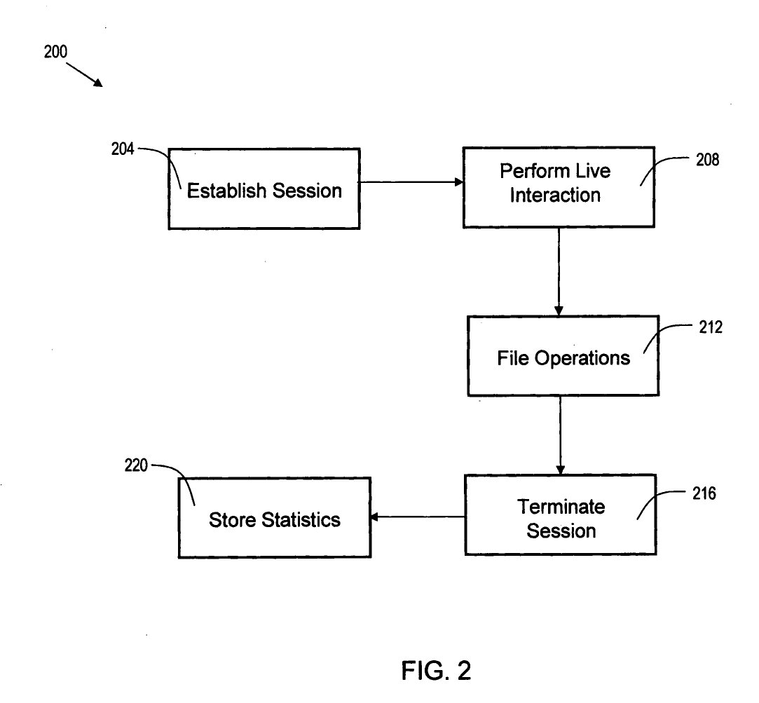

FIG. 2 is a flow chart 200 indicating steps during a use of the present invention. In step 204, a communication session is established. Prior to this step, an internet banner has been served to a client computer of a caller by standard means as is known in the art, such as, for example, via HTTP from an ad server, such as DoubleClick, of New York, New York, which is now a subsidiary of Google, of Mountain View, Calif. The session is initiated by the client computer of the caller, which communicates with the media server (112 of FIG. 1) to start the session. In one embodiment, media server 112 is Flash Media Server, and the communication protocol used is RTMP (Real Time Messaging Protocol) or an RTMPE variant (supporting encryption) over TCP. Once the session request is established, the media server 112 sends a request to a client computer of a presenter. When the presenter acknowledges (effectively “answering” the request) the session request, an acknowledgement is sent from the presenter client computer, which is executing support application (108 of FIG. 1) to the media server 112, and the session is now established. Once the session is established, the caller and presenter perform live interaction. The live interaction can take a variety of forms, such as text chat, audio chat, one-way video chat (from the presenter to the caller), or two-way video chat (interactively between presenter and caller). In one embodiment, the text chat is two-way chat between a caller and a presenter. In another embodiment, the text chat is group chat, which takes place with more than two parties. Note that for the purposes of this disclosure, the term “video chat” means that both video and audio are being streamed, or otherwise transmitted, between a presenter and a caller.

One of the important advantages of the present invention is that the aforementioned interactive communication is invoked directly from the internet banner, without the need to launch another application, or pop-up browser window. This is important because studies show that internet advertising loses effectiveness as more additional steps are required to get more information. By using the present invention, a caller (e.g. customer) can quickly access a presenter (live customer service representative) without the additional delay of launching another application. Furthermore, since many internet users have pop-up blockers, avoiding the need for a pop-up can increase the chance that an internet banner advertisement will result in a sales lead.

In addition to performing live interaction, the present invention may be enabled within an e-book (electronic document) internet banner. With this embodiment, the caller may also elect to perform file operations 212. The file operations may include, but are not limited to, saving a file to the client computer of a caller, printing a file, viewing the contents of a file, or e-mailing a file to one or more e-mail addresses.

Once the live interaction completes, the session is terminated in step 216 via the caller or presenter. Once terminated, the statistics pertaining to the transaction are stored in step 220. As mentioned previously, recorded information may include, but is not limited to, the time and date of each transaction, the text chat logs for each transaction, audio and video chat recordings of each transaction, location of callers, IP address of callers, the duration of the transaction, and the activation URL of the internet banner that invoked the banner application 104 when selected by the caller.

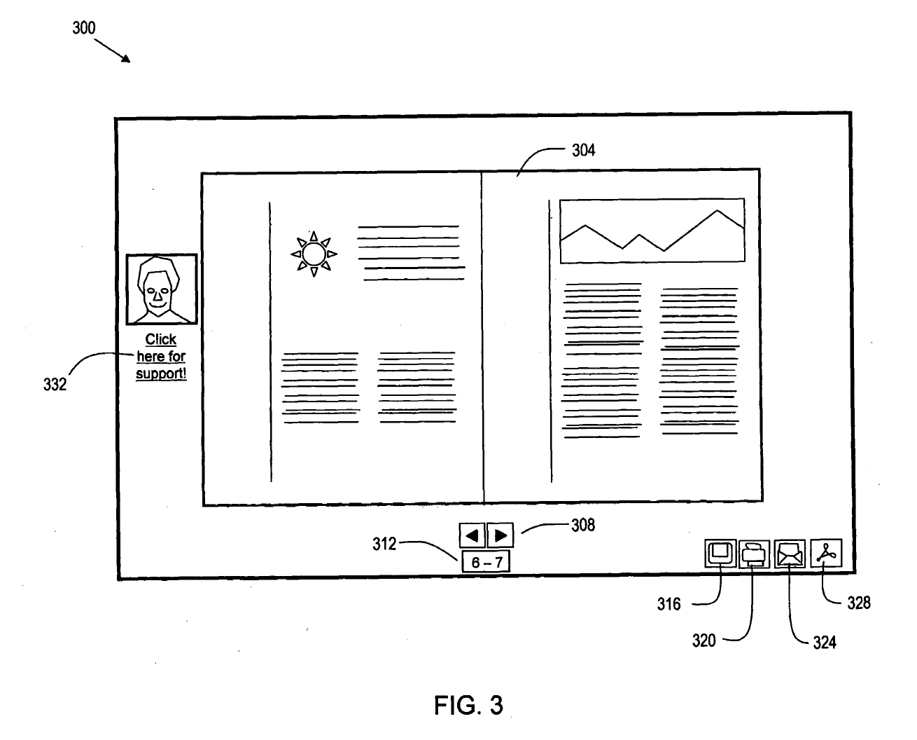

FIG. 3 is an exemplary banner in accordance with the present invention. In this case, an e-book context 300 is shown. The e-book context 300 comprises renderer 304 that renders information in a “book-like” manner. Page controls 308 allow the user to view the various pages of the document displayed in reader application 304. Page indicator 312 shows which pages are currently being displayed. File save button 316 allows a user to save the file to their client computer, or other network location. Print button 320 allows the user to print the document. Send button 324 allows the user to send the document to one or more e-mail addresses. PDF button 328 allows the user to convert the document to PDF format, and save to their client computer, or other network location. Banner 332 is shown on the left margin of the e-book context 300. If the user clicks banner 332 with a mouse (or other means of selection), an interactive session is initiated.

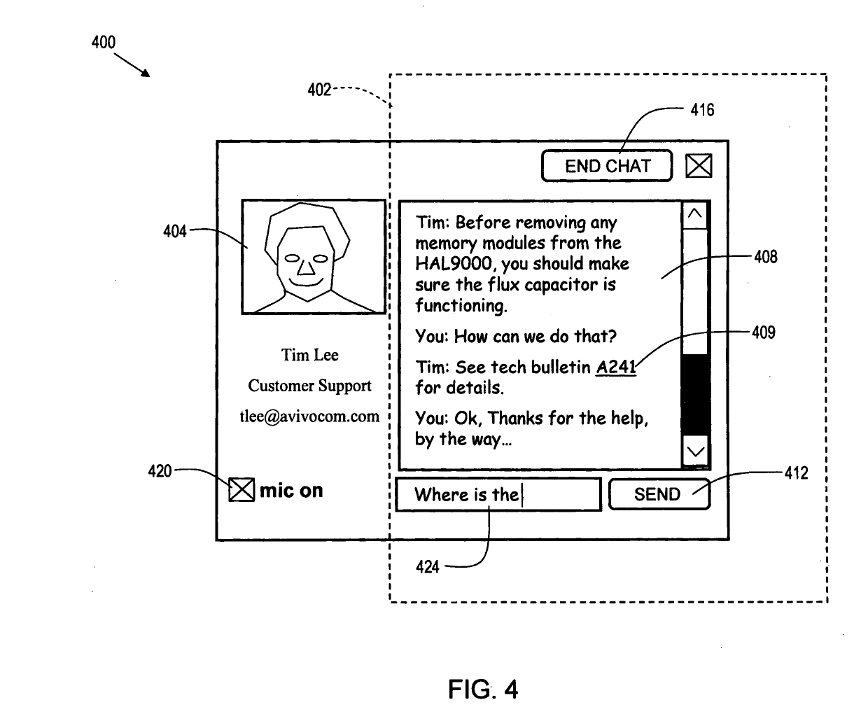

FIG. 4 is a detailed view of an interactive banner 400 during an interactive session. The Banner sizes can be any size, but are preferably sizes that fall within the standards set by the Interactive ADVERTISING BUREAU STANDARD.

The Video is preferably pure Flash Video.

In this embodiment, banner 400 comprises text chat interface 402. Text chat interface 402 comprises conversation window 408, which shows a log of ongoing text dialog. The text in text chat interface 402 may also include hyperlink 409, which can provide the user a link to another document or file. This document or file can then be accessed or saved to the client computer. More than one hyperlink may be present within the text window 408. Text entry box 424 allows the user to enter in new text. The user invokes send text control 412 to send the text in text entry box 424 to a presenter. When the transaction is complete, the user can terminate the session (analogous to step 216 of FIG. 2) by invoking the end chat control 416.

The present invention may also have a “file push” capability. This is the process of serving a web page by using PHP scripts to create a pop up page and send it to the desktop of the customer connected to the back end console.

Interactive banner 400 also comprises video window 404, which renders live video of a presenter (e.g. a customer service representative of a company). Microphone control 420 allows a user to enable or disable a microphone that may be used for conducting audio chat.

It will be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

What is claimed is:

1. A system for providing interactivity within an interne banner, comprising:
a media server;
a banner application, said banner application configured to execute from within the internet banner and communicate with said media server;
a support application, said support application configured to communicate with said media server.

2. The system of claim 1, further comprising:
a database;
a web server, said web server configured to communicate with the media server and said database; and
an administration application, said administration application configured to communicate with said web server, whereby the database is configured to store usage statistics relating to user interaction with the banner application.

3. The system of claim 1, wherein the banner application comprises means for text chatting.

4. The system of claim 1, wherein the banner application comprises means for streaming live audio within said interne banner.

5. The system of claim 1, wherein the banner application comprises means for streaming live video within said interne banner.

6. The system of claim 1, wherein the banner application comprises means for downloading one or more files from a server.

7. The system of claim 3, wherein the banner application comprises means for group text chatting.

8. The system of claim 2, wherein the banner application comprises means for recording user actions in the database.

9. The system of claim 1, wherein said media server is a flash media server.

10. The system of claim 2, wherein said banner application is executing in an e-book context.

11. The system of claim 10, wherein the usage statistics stored in the database comprise the number of occurrences of downloads and e-mailings of an e-book.

12. The system of claim 11, wherein the usage statistics stored in the database further comprise the number of pages viewed, and the number of pages printed.

13. An interactive internet banner, comprising:
a video window, said video window configured and disposed to display live video; and
a text chat interface, said text chat interface comprising a conversation window, a text entry box, a send text control, and an end chat control.

14. The interactive internet banner of claim 13, further comprising a microphone control, configured to enable or disable input from a microphone.

15. A method for providing an interactive internet banner, comprising the steps of:
serving an interactive internet banner to a client computer, said interactive internet banner configured to receive user input via a user interface;
establishing a communication session between the client computer and a media server, based on user input received via the user interface; and
conducting live interaction with another user.

16. The method of claim 15, further comprising the steps of:
ending the communication session; and
storing usage statistics from the communication session in a database.

17. The method of claim 15, wherein the step of conducting live interaction comprises performing group text chatting.

18. The method of claim 17, wherein the step of conducting live interaction further comprises one-way video chatting.

19. The method of claim 15, wherein the step of conducting live interaction further comprises audio chatting.

20. The method of claim 19, wherein the step of conducting live interaction further comprises two-way video chatting.
